(19) United States
(12) Patent Application Publication
(10) Pub. No.: US 2016/0011856 A1
(43) Pub. Date: Jan. 14, 2016

(54) USER INTERFACE CREATION SYSTEM AND CREATION METHOD

(71) Applicant: HITACHI, LTD., Chiyoda-ku, Tokyo (JP)

(72) Inventor: Hidenori AKATOKI, Tokyo (JP)

(73) Assignee: Hitachi, Ltd., Tokyo (JP)

(21) Appl. No.: 14/770,490

(22) PCT Filed: Nov. 22, 2013
(86) PCT No.: PCT/JP2013/081494

§ 371 Date: Aug. 26, 2015

(51) Int. Cl. G06F 9/44; G06F 3/0484

(52) U.S. Cl. CPC G06F 8/38; G06F 3/0484

(57) ABSTRACT

The present invention provides a user interface creation system and a creation method that are able to improve user interface creation efficiency. A prescribed process (100) that is executed using a computer is created by combining a plurality of sub-process steps (101(1)) and (101(2)) for executing respective prescribed sub-processes. The sub-process steps respectively have sub-process user interfaces that correspond to sub-process contents. A storage operation automation system is configured to detect the sub-process steps comprising the prescribed process, and create a general user interface to be used in the prescribed process by using the sub-process user interfaces of the detected sub-process steps.

### TECHNICAL FIELD

The present invention relates to a user interface creation system and a creation method.

### BACKGROUND ART

In recent years, attention has focused on products for automating the management and operation of a computer system in order to increase computer system operations management efficiency. These products automate operations management by creating a workflow from a plurality of tasks performed by an administrator, and systematizing this workflow. Prior art disclosed in PTL 1 provides a single all-inclusive service by combining a plurality of software components. The prior art disclosed in PTL 1 uses past historical information to make available combination candidates so that a user can easily combine the software components.

### CITATION LIST

### Patent Literature

### [PTL 1]

### Japanese Patent Application Publication No. 2007-334627

### SUMMARY OF INVENTION

### Technical Problem

In the prior art disclosed in PTL 1, the input value for each software component changes each time the combination of software components changes, and as such, it is necessary to redesign the user interface for the service as a whole each time the input values change. Therefore, in the prior art, it is troublesome to create a user interface for the service as a whole, thus leaving room for improvement from the standpoint of workability. In addition, the input/output of one software component must be matched to the input/output of another software component according to how the software components are combined, and since the user performs the matching manually, there is the likelihood of human error. Therefore, there is also room for improvement in the prior art from the standpoint of reliability.

With the foregoing problems in mind, an object of the present invention is to provide a user interface creation system and a creation method that are able to improve user interface creation efficiency. Another object of the present invention is to provide a user interface creation system and a creation method that are able to improve user interface creation efficiency and reliability.

### Solution to Problem

A user interface creation system according to a first aspect of the present invention is configured to create a user interface for a prescribed process to be executed using a computer, wherein the prescribed process is created by combining a plurality of sub-process steps for executing prescribed sub-processes, the respective sub-process steps each having a sub-process user interface that corresponds to the content of the sub-process, and a general user interface for use in the prescribed process is created by detecting the sub-process steps comprising the prescribed process, and using the sub-process user interfaces of the respective detected sub-process steps.

The general user interface may also be created on the basis of required input data by determining the input data required for the prescribed process on the basis of input data and output data of the sub-processes comprising the prescribed process.

Other input data besides the required input data from among the input data of the sub-processes comprising the prescribed process may be configured to be uninputtable in the general user interface.

### Advantageous Effects of Invention

According to the present invention, a user interface for a prescribed process that includes a plurality of sub-process steps can be created using the user interfaces of the sub-process steps, making it possible to enhance user interface creation efficiency.

### BRIEF DESCRIPTION OF DRAWINGS

FIG. 1 is a schematic diagram showing a relationship between a flow configured from a plurality of components, a user interface for each component, and a service user interface.

FIG. 2 is an example of the screen of the service user interface shown in FIG. 1.

FIG. 3 is a block diagram of an overall system that includes a management-target storage system, and a storage operation automation system that issues instructions for operation management.

FIG. 4 is a schematic diagram showing hardware configurations of a host computer and a storage apparatus.

FIG. 5 is a schematic diagram showing the configuration of a management computer for configuring a storage operation automation system.

FIG. 6 is a schematic diagram showing the configuration of an information display apparatus for configuring the storage operation automation system.

FIG. 7 is an example of the configuration of a component table.

FIG. 8 is an example of the configuration of a component information table.

FIG. 9 is an example of the configuration of a service information table.

FIG. 10 is an example of the configuration of a flow information table.

FIG. 11 is an example of the configuration of a table for managing information showing an association between components.

FIG. 12 is an example of the configuration of a table for managing service input/output information.

FIG. 13 is a sequence chart showing the overall operation of a service edit screen.

FIG. 14 is a flowchart showing the processing for editing an automation operation flow.

FIG. 15 is a flowchart showing the processing for storing service information.

FIG. 16 is a flowchart showing the processing for displaying the service edit screen.

FIG. 17 is a flowchart showing the processing when installing a component.

FIG. 18 is a schematic diagram showing the relationship between the user interface of each component and the service user interface according to a second example.

FIG. 19 is an example of the service user interface screen.

FIG. 20 is a schematic diagram showing the relationship between the user interface of each component and the service user interface according to a third example.

FIG. 21 is an example of the service user interface screen.

FIG. 22 is an example of a screen for editing a service according to a fourth example.

FIG. 23 is an example of a screen for instructing service execution.

FIG. 24 is an example of a screen showing a service execution result.

### DESCRIPTION OF EMBODIMENTS

The embodiment will be explained by referring to the drawings. The examples explained hereinbelow do not limit the invention according to the claims, and all of the various components and combinations thereof explained in the examples may not be essential to the solution of the invention.

Furthermore, in the following explanation, various types of information may be explained using the expression “aaa table”, but the various information may also be expressed using a data structure other than a table. To show that the various information is not dependent on the data structure, “aaa table” can be called “aaa information”.

Also, in the following explanation, there may be cases where processing is explained by simply treating a management computer and a host computer as the doers of the action, but this processing is executed by a microprocessor (for example, a CPU (Central Processing Unit)) of a control device provided by the computer.

In the present embodiment, as will be described later, a component user interface 103 is configured beforehand for each software component 101. A user, such as a system operations administrator, defines a flow of a service 100 by selectively combining desired software components 101. In the present embodiment, a user interface for a service 100 is automatically created by merging the component user interfaces 103 of the respective components that comprise the flow of the service 100.

### Example 1

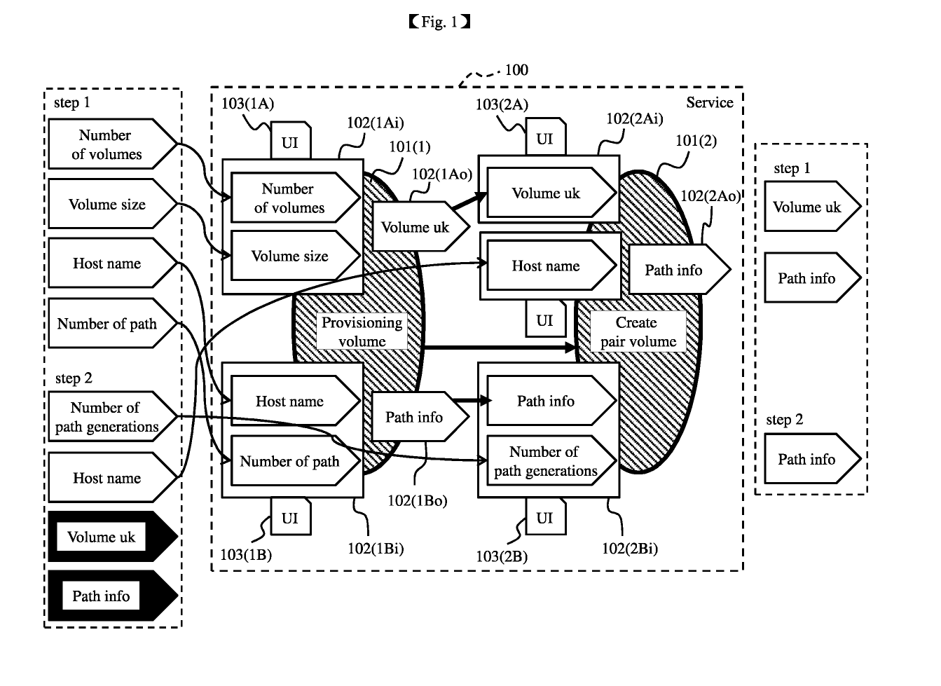

FIG. 1 is a schematic diagram showing the relationship between a service 100 user interface and user interfaces 103 of the components 101 according to a first example. In this example, a storage system that includes a host computer 3 and a storage apparatus 4 will be explained as an example of a computer system. In this example, a case that applies the present invention to a service for managing the operation of the storage system will be explained. First, the configuration of a service 100, and the configuration of a screen for using the service 100 will be explained, and then the configuration of a storage system will be explained.

The service 100, as mentioned above, is for managing the operation of a storage system that includes a host computer 3 and a storage apparatus 4. The service 100 is configured from a single flow. The single flow is configured by combining a plurality of (for example, two) software components 101(1) and 101(2).

The service 100 shown in FIG. 1 is configured to execute a plurality of steps. A first step is executed by a first software component 101(1). A second step is executed by a second software component 101(2). When there is no particular need to make a distinction between the two components, they will be called software component 101.

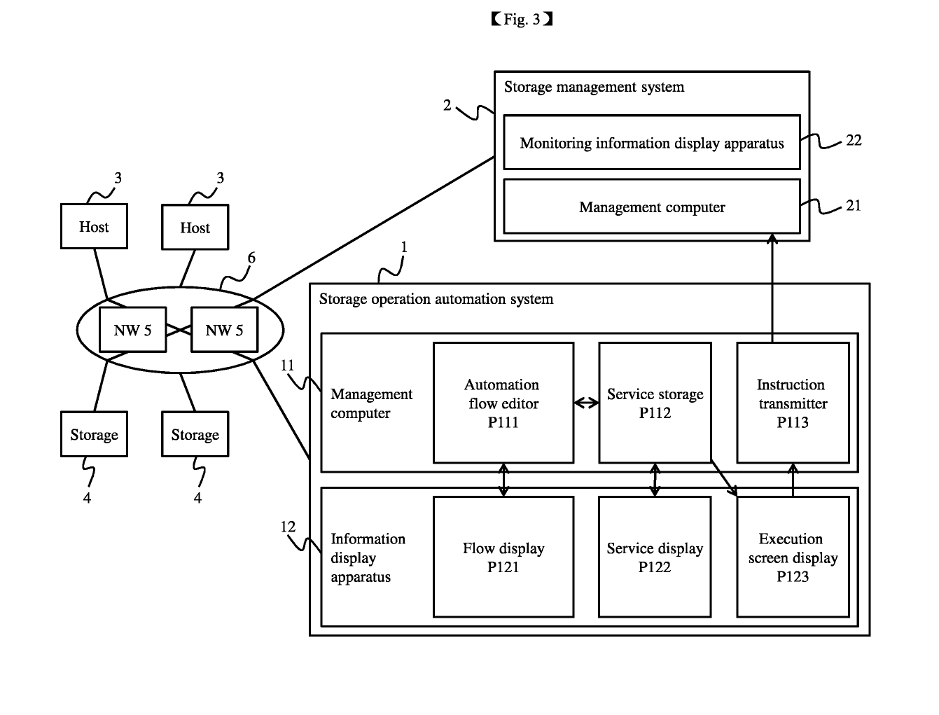

Each software component 101 is an example of a “sub-process”. Each step can be considered as an example of a “sub-process”. Each software component 101 is provided beforehand in a storage operation automation system 1 (to be described later using FIG. 3), but the present invention is not limited to this, and the software components 101 can be added to the system 1 thereafter.

Each software component 101 provides a function related to changing a storage configuration. As a function related to changing a storage configuration, for example, there is the creation of a thin provisioning volume (can also be called a primary volume or a copy-source volume), the creation of a pair volume (can also be called a secondary volume or a copy-destination volume), the creation of a database store, and the creation of a database volume. The present invention is not limited thereto, and there may also a software component that is used for combining software components, and a software component capable of general-purpose use. As such a software component, there is a software component for repetitive execution, a file transfer component, and a file execution component.

Each component 101(1) and 101(2) has an input property and an output property. A user, for example, inputs information (data) to a software component via a GUI (Graphical User Interface), a CLI (Common Language Infrastructure), an API (Application Programming Interface), and so forth. A value outputted from a software component is storage configuration information and the like subsequent to the software component having been executed.

The input property and the output property belong to any prescribed property group from among a plurality of property groups configured beforehand.

The first software component 101(1) has the input properties “number of volumes” and “volume size” that belong to a first input property group 102(1Ai), and the input properties “hostname” and “number of paths” that belong to a second input property group 102(1Bi). User interfaces 103(1A) and 103(1B), which are examples of “sub-process user interfaces”, are associated beforehand with the respective property groups 102(1Ai) and 102(1Bi).

The first software component 101(1) has an output property “volume identifier” that belongs to a first output property group 102(1Ao) and an output property “path information” that belongs to a second output property group 102(1Bo).

The same as the first software component 101(1), the second software component 101(2) also has the input properties “volume identifier” and “hostname” that belong to a first input property group 102(2Ai), and the input properties “path information” and “number of path generations” that belong to a second input property group 102(2Bi). User interfaces 103(2A) and 103(2B), which are examples of “sub-process user interfaces”, are associated beforehand with the respective property groups 102(2Ai) and 102(2Bi). The second software component 101(2) outputs “path information” that belongs to an output property group 102(2Ao).

In the present specification, in the property groups 102, an (i) is appended after the reference sign 102 of the property group related to input. An (o) is appended to the reference sign 102 of the property group related to output. In a case where the software component 101 has input property groups 102(i), the reference sign A is added to the one input property group 102, and the reference sign B is added to the other input property group 102. Therefore, the reference sign 102(1Ai) is assigned to the one input property group of the first software component 101(1), and the reference sign 102(1Bi) is assigned to the other input property group of the first software component 101(1). Similarly, the reference sign 102(2Ai) is assigned to the one input property group of the second software component 101(2), and the reference sign 102(2Bi) is assigned to the other input property group of the second software component 101(2).

In a first step, a thin provisioning volume is created in the storage apparatus 4, and a path is configured to this thin provisioning volume to connect the thin provisioning volume to a host computer. In a second step, a pair volume that forms a copy pair with the thin provisioning volume is created, and data is copied from the thin provisioning volume to the pair volume. In the service 100 shown in FIG. 1, the thin provisioning volume, which is a primary volume, and the pair volume, which is a secondary volume, are respectively used by different host computers.

Look at the first software component 101(1) that executes the first step. In the present example, the first software component 101(1) is for creating the thin provisioning volume, and when a prescribed data is input, outputs the prescribed data. As input data, for example, there is “number of volumes”, “volume size”, “hostname”, and “number of paths”. When these prescribed data are inputted, the first software component 101(1) outputs “volume identifier” and “path information” as the prescribed output.

Look at the second software component 101(2). In the present example, the second software component 101(2) creates a pair volume (can also be called a secondary volume or a copy-destination volume) for forming a copy pair with the thin provisioning volume created by the first software component 101(1). A pair volume is formed when a “volume identifier”, “hostname”, “path information” and “number of path generations” are inputted to the second software component 101(2), for example. The second software component 101(2) outputs “path information”.

A portion of the data outputted by the first software component 101(1) can be used as input data of the second software component 101(2). In this example, the “volume identifier” and the “path information” outputted by the first software component 101(1) are used as-is as the input data of the second software component 101(2). Therefore, as indicated by the blackened areas in FIG. 1, the “volume identifier” and “path information” from among the data inputted to the second software component 101(2) do not need to be inputted by the user. This is because, as was described above, the output values of the first software component 101(1) are used. Therefore, the input of erroneous values by the user can be prevented in advance.

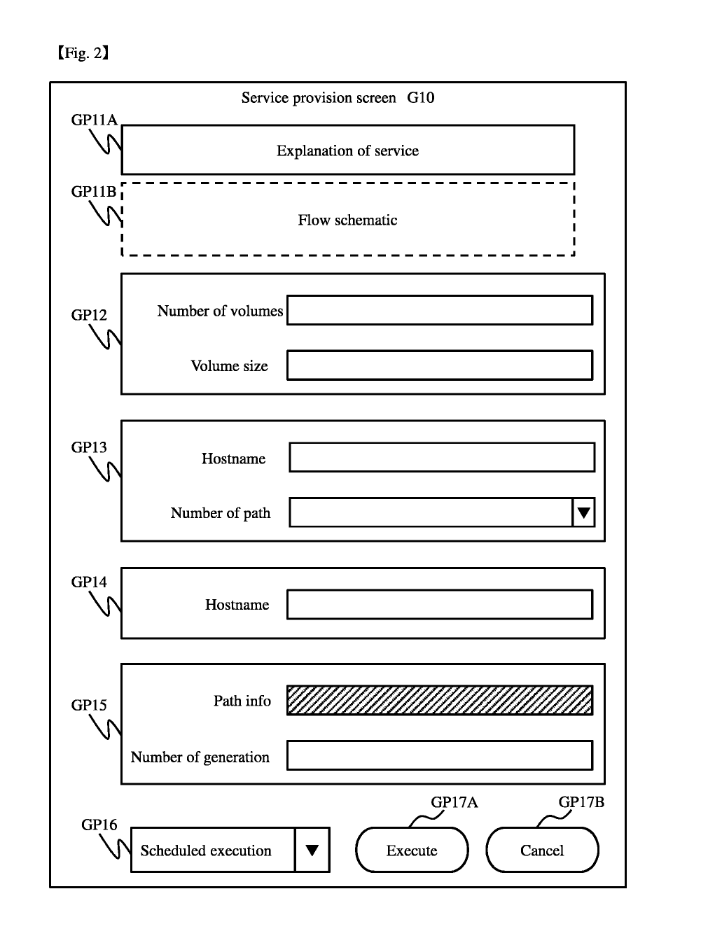

FIG. 2 is an example of a screen G10 for providing the service 100 to the user. The user can utilize the service 100 by inputting a value into a service provision screen G10.

The service provision screen G10, for example, is provided with a service overview part GP11, a volume setup part GP12, a primary volume-side host setup part GP13, a secondary volume-side host setup part GP14, a number of path generations setup part GP15, an execution type specification part GP16, and a button GP17.

Service overview part GP11 is a generic term that includes a service explanation part GP11A and a flow schematic GP11B. The service explanation part GP11A is a display area for explaining the content of the service 100 using text. The flow schematic GP11B is a display area for illustrating a schematic block diagram of the flow that configures the service 100. The flow schematic GP11B, for example, displays the configuration of the service 100 shown in FIG. 1.

Each of the setup parts GP12 to GP15 corresponds to the user interfaces 103 of the input property groups 102(i) of the respective software components 101. The volume setup part GP12 corresponds to the user interface 103(1A) of the input property group 102(1Ai) of the first software component 101(1). The user inputs the number of thin provisioning volumes created and the sizes of the volumes to the volume setup part GP12.

The primary volume-side host setup part GP13 corresponds to the user interface 103(1B) of the input property group 102(1Bi) of the first software component 101(1). The user inputs to the primary volume-side host setup part GP13 a hostname for identifying the host that uses the thin provisioning volume, and a number of paths that connect to the thin provisioning volume.

The secondary volume-side host setup part GP14 corresponds to the user interface 103(2A) of the input property group 102(2Ai) of the second software component 101(2). The user inputs to the secondary volume-side host setup part GP14 a hostname for identifying the host that uses the pair volume.

The number of path generations setup part GP15 corresponds to the user interface 103(2B) of the input property group 102(2Bi) of the second software component 101(2). The user can only input the number of generations to the number of path generations setup part GP15. The existence of path information is displayed on the screen; the user is not able to input the value. This is because, as was described above, the path information used at pair volume creation utilizes the output value of the first software component 101(1).

The execution type specification part GP16 specifies the execution timing of the service 100. As the execution timing, for example, there is “immediate execution” and “scheduled execution”. Scheduled execution signifies that the service 100 is executed in accordance with a schedule. In the scheduled execution, for example, it is possible to specify an execution date/time, and/or to specify an execution cycle (daily at 12 noon, daily at 12 midnight, and so forth).

Button GP17, for example, is a generic term for an execute button GP17A and a cancel button GP17B. The execute button GP17A is for instructing that the storage management system 2 (to be described later using FIG. 3) execute the service 100. The cancel button GP17B is for canceling the input to the screen G10.

FIG. 3 is a block diagram of an overall system that includes a storage operation automation system 1, a storage management system 2, and a management-target storage system.

The management-target storage system, for example, is provided with one or more host computers (host hereinbelow) 3, one or more storage apparatuses 4, and one or more switch apparatuses 5, and these apparatuses 3, 4, and 5 are connected by a communication network 6. The storage apparatus 4 provides the host 3 with a logical volume.

The storage management system 2 manages the configuration of a storage system that includes the host 3, the storage apparatus 4, and the switch apparatus 5. The storage management system 2, for example, is provided with a management computer 21, and a monitoring information display apparatus 22.

The management computer 21 is a computer for issuing an instruction for changing the configuration of the storage system. The management computer 21 provides a prescribed instruction to the storage apparatus 4 in accordance with a command from the storage operation automation system 2. The storage apparatus 4 changes the storage configuration in accordance with this instruction.

The monitoring information display apparatus 22 is connected to the management computer 21 and displays information related to the storage system managed by the management computer 21. The monitoring information display apparatus 22, for example, displays various types of performance information, and configuration information regarding the storage apparatus 4. The monitoring information display apparatus 22 and the management computer 21 may be configured as a single computer.

The storage operation automation system 1 (operation automation system 1 hereinbelow) is a system that supports the automation of the operations management of the storage system. The operation automation system 1, for example, is provided with a management computer 11 and an information display apparatus 12.

The management computer 11 is for editing and saving the flow that configures the service 100, and for instructing that the storage management system 2 execute the saved flow (that is, execute the service 100). The management computer 11, for example, is configured so as to be able to execute an operation automation flow editing program P111, a service information storage program P112, and a configuration change instruction transmission program P113.

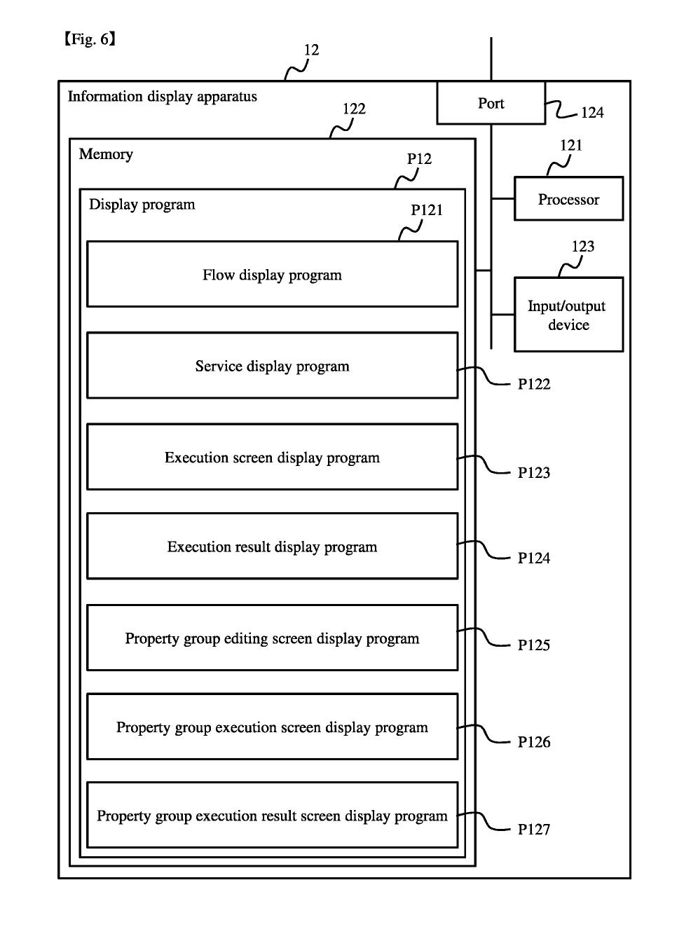

The information display apparatus 12 provides the user with a screen and so forth related to the respective programs P111, P112, and P113 executed by the management computer 11. The information display apparatus 12, for example, is configured as to be able to execute an operation automation flow editing screen display program P121, a service editing screen display program P122, a service execution screen display program P123, and other programs P124 to P127 that will be described later (described later using FIG. 6). Furthermore, the information display apparatus 12 and the management computer 11 may be configured in an integrated manner.

The flow of processing according to each computer program will be described later, but first the function of each computer program will be explained. The names of the computer programs may be displayed in an abbreviated manner below. For example, the operation automation flow editing program P111 is displayed as “automation flow editor”, the service information storage program P112 is displayed as “service storage”, and the configuration change instruction transmission program P113 is displayed as “instruction transmitter”. The operation automation flow editing screen display program P121 is displayed as “flow display”, the service editing screen display program P122 is displayed as “service display”, and the service execution screen display program P123 is displayed as “execution screen display”. The operation automation flow may also be abbreviated as “flow”.

The automation flow editing program P111 has functions for creating and/or editing a flow (that is, the content of the service 100) for automatically performing storage system operations management. The flow display program P121 has functions for acquiring from the automation flow editing program P111 information related to a flow that is either to be newly created or has been created, and displaying same on a display apparatus of the information display apparatus 12. A user (a storage administrator or the like), who has flow editing authority, edits the flow using an input apparatus of the information display apparatus 12.

The service storage program P112 has functions for acquiring from the automation flow editing program P111 information related to the flow (that is, information related to the service content), and storing same in a prescribed storage area such as a memory. The service display program P122 has functions for classifying, by property group, data for inputting to the respective software components 101 and determining whether this data input is necessary on the basis of information (flow information, which is the service content) received from the service storage program P112.

That is, the service display program P122 selects an input item to be displayed on the service provision screen G10 and determines the configuration of the service provision screen G10 on the basis of flow-related information. Specifically, the service display program P122 determines the property group for displaying on the screen G10, and in addition determines an input property for configuring in an inputtable state from among the input properties (input items) of the property group.

The execution screen display program P123 has functions for acquiring flow-related information from the service storage program P112, and displaying an execution screen for instructing that the storage management system 2 execute the service 100.

The instruction transmission program P113 has a function for issuing a command for instructing that the storage management system 2 execute a service. The instruction transmission program P113 acquires the flow information from the service storage program P112, creates an instruction for the storage management system 2 to operate in accordance with the flow, and transmits this instruction to the storage management system 2.

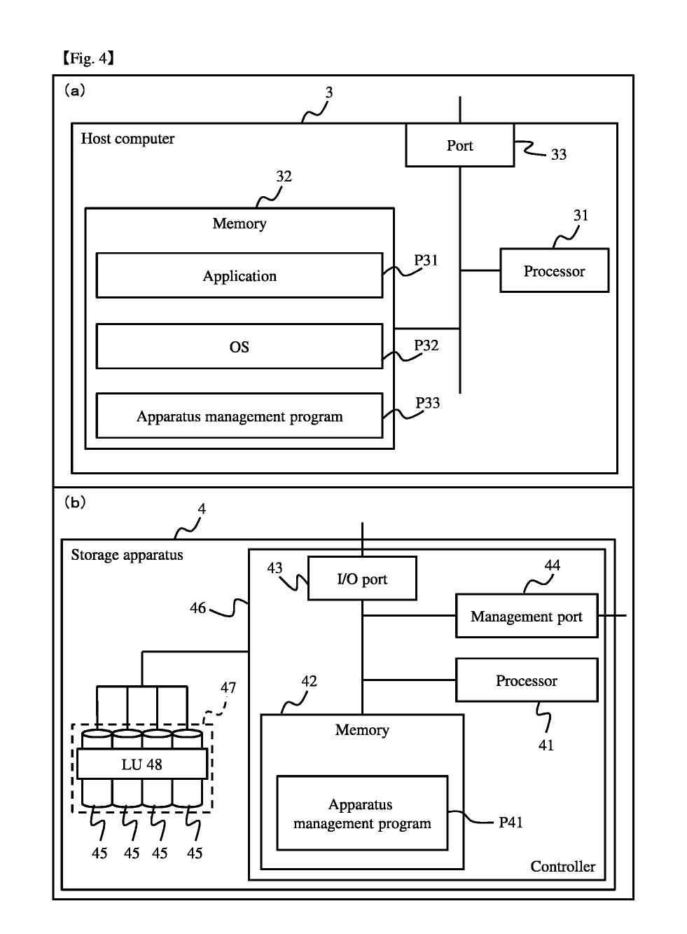

FIG. 4 shows an example of the configuration of the host 3. The host 3, for example, is provided with a microprocessor 31, a memory 32, and a communication port 33, and these components are interconnected by a bus or the like. The memory 32 is not limited to a semiconductor memory. The memory may be a storage apparatus like a hard disk drive. The memory 32, for example, stores an application program P31, an operating system P32, and an apparatus management program P33. These computer programs P31, P32, and P33 are executed by the microprocessor 31 to realize prescribe functions.

The application program P31, for example, executes the prescribed process using data stored in a logical volume 48 of the storage apparatus 4 similar to a customer management program or an image delivery program. The apparatus management program P33 is a control program for using the storage apparatus 4. The communication port 33 is an apparatus for communicating with the storage apparatus 4 via the communication network 6.

The storage apparatus 4 is provided with a plurality of storage devices 45, and a controller 46 for controlling the operations of each of the storage devices 45. The controller 46 is provided with a microprocessor 41, a memory 42, an I/O (Input/Output) port 43, and a management port 44.

The memory 42 is provided with an apparatus management program P41. The apparatus management program P41 is a control program for controlling the operation of the storage apparatus 4. The I/O port 43 is connected to the communication port 33 of the host 3 via the communication network 6, receives a command or the like from the host 3, and transmits data to the host 3. The management port 44 is connected to the storage management system 2 via the communication network 6.

The storage device 45, for example, is a device capable of reading and writing data, such as a hard disk drive, flash memory device or the like. The storage areas of a plurality of storage devices 45 are grouped together as a parity group 47, and a logical storage area 48 of a prescribed size can be formed from this group of storage areas. The logical storage area 48 is called a logical volume. A communication path for host 3 access is configured to the logical volume 48. This makes it possible for the host 3 to access a desired logical volume 48 via the I/O port 43 to read/write data.

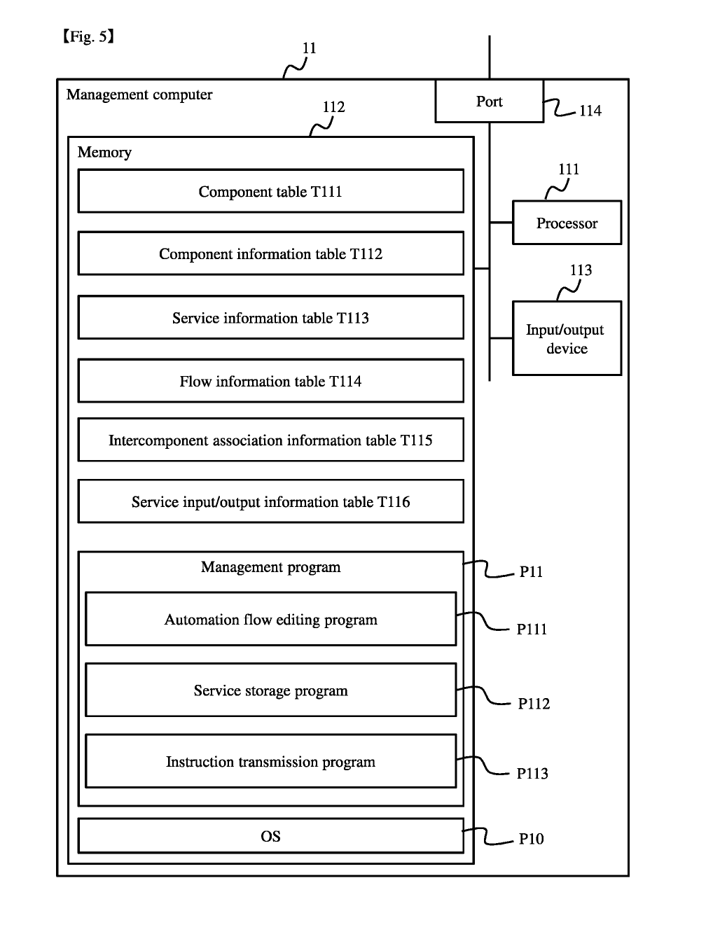

FIG. 5 shows an example of the configuration of the management computer 11 of the storage operation automation system 1. The management computer 11, for example, is provided with a microprocessor 111, a memory 112, an input/output device 113, and a communication port 114.

The memory 112 is not limited to a semiconductor memory, and may be a hard disk drive. The memory 112 stores computer programs and management tables. The computer programs stored in the memory 112 are an operating system P10 and a management program P11. The management program P11 includes the aforementioned automation flow editing program P111, service storage program P112, and instruction transmission program P113.

The management tables stored in the memory 112, for example, include a component table T111, a component information table T112, a service information table T113, a flow information table T114, an intercomponent association information table T115, and a service input/output information table T116. Each table will be explained in detail later.

The input/output device 113 is for inputting information to the management computer 11 and/or outputting information from the management computer 11. The communication port 114 is connected to the respective hosts 3 and respective storage apparatuses 4 via the communication network 6. In a case where the switch apparatus 5 is treated as the management target, the management computer 11 is also connected to the respective switch apparatuses 5.

FIG. 6 shows an example of the configuration of the information display apparatus 12 of the storage operation automation system 1. The information display apparatus 12, for example, is provided with a microprocessor 121, a memory 122, an input/output device 123, and a communication port 124.

The memory 122 is not limited to a semiconductor memory, and may be a hard disk drive. The memory 122 stores a display program P12. The display program P12, in addition to the aforementioned flow display program P121, service display program P122, and execution screen display program P123, includes an execution result display program P124, a property group editing screen display program P125, a property group execution screen display program P126, and a property group execution result screen display program P127.

The execution result display program P124 is for displaying the result of executing the service 100. The property group editing screen display program P125 is for editing the property group configuration displayed on the service provision screen and so forth. The property group execution screen display program P126 is for displaying on the service 100 execution screen the state of each property group at the time of execution. The property group execution result screen display program P127 is for displaying execution results by property group on the screen for displaying the results of service 100 execution.

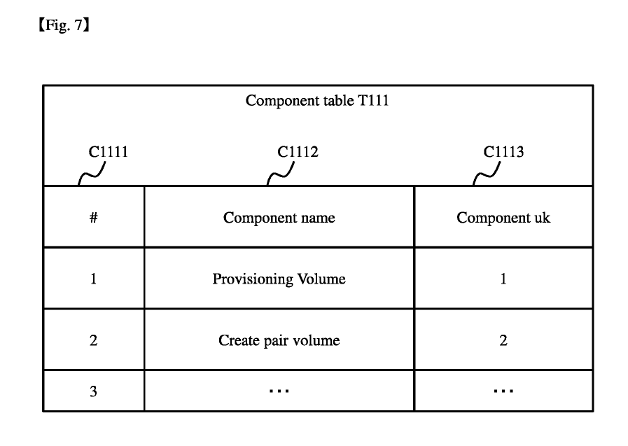

Examples of the configurations of the management tables T111 to T116 of the management computer 11 in the operation automation system 1 will be explained by referring to FIGS. 7 to 12. Furthermore, the configurations of the respective tables shown below are illustrative, and a plurality of tables may be consolidated into a single table, and/or a single table may be divided into a plurality of tables.

FIG. 7 shows the component table T111 for managing the software components 101. The component table T111, for example, associatively manages a management number C1111, a component name C1112, and a component identifier C1113. The component name C1112 is the name of the software component 101. The component identifier C1113 is information for uniquely identifying the software component 101 in the system shown in FIG. 1.

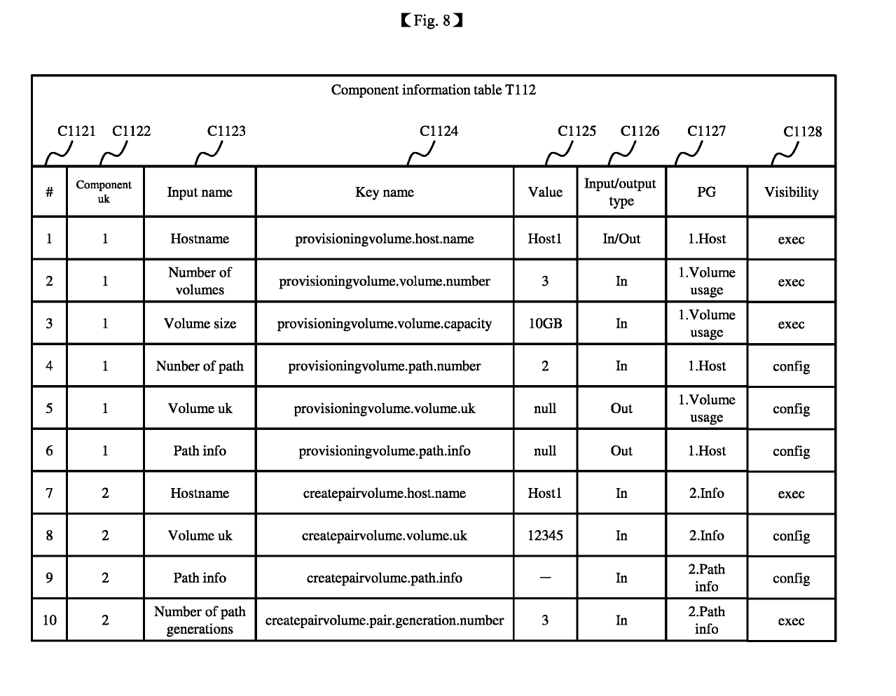

FIG. 8 shows the component information table T112 for managing detailed information regarding the software components 101. The component information table T112, for example, associatively manages a management number C1121, a component identifier C1122, an input name C1123, a key name C1124, a value C1125, an input/output type C1126, a property group C1127, and visibility information C1128.

The input name C1123 is the name of data inputted to the software component 101 identified by the component identifier C1122. The name of data outputted from the software component 101 is also managed by the input name C1123. The key name C1124 is information for uniquely identifying a record. The key name, for example, is created by adding the input name to the software component name.

The value C1125 is an initial value configured beforehand as input data identified by the input name C1123.

The input/output type C1126 is information for distinguishing whether the data identified by the input name C1123 is an input value or an output value.

In the input/output type C1126, “In” is stored in the case of an input value (input property), “Out” is stored in the case of an output value (output property), and “In/Out” is stored in a case where both an input and an output are capable of being used.

The property group C1127 is information showing the property group name to which the input properties and the output properties of the software components 101 belong. The property group name, for example, is created by adding information (Host, Info, and so forth) representing component identifier values and property group types. The visibility information C1128 is for controlling a display on the service provision screen G10.

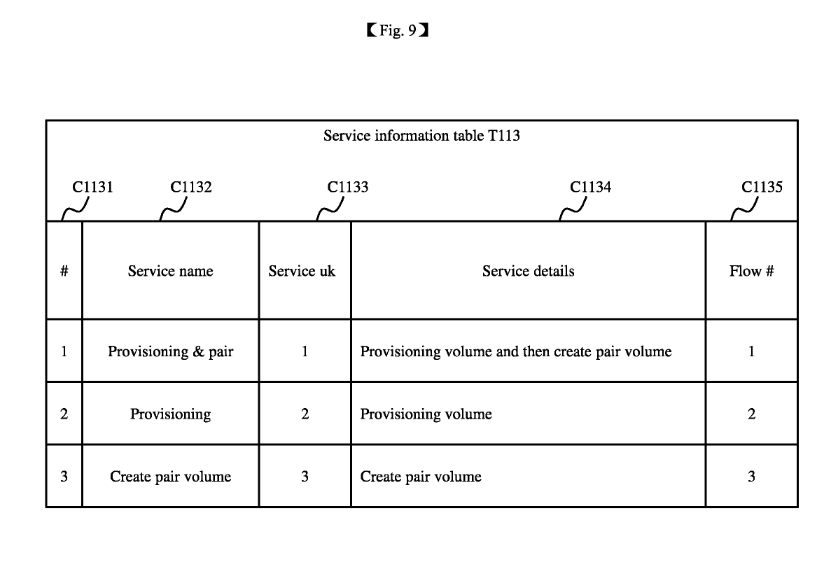

FIG. 9 shows the service information table T113 for managing information regarding the service 100. The service information table T113, for example, associatively manages a management number C1131, a service name C1132, a service identifier C1133, service details C1134, and a flow number C1135.

The service name C1132 is the name of the service 100. The user who created the service can arbitrarily configure the service name therefor. The service identifier C1133 is information for uniquely identifying the service 100. The service details C1134 is information showing the content provided by the service 100 identified in the service identifier C1133. The flow number C1135 is information for identifying the flow of the service 100 identified in the service identifier C1133.

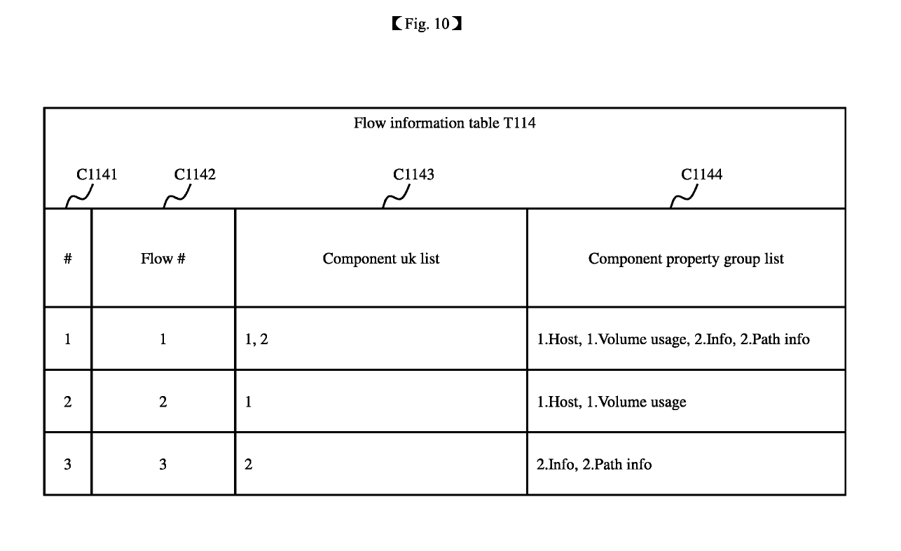

FIG. 10 shows a table T114 for managing information regarding an operation automation flow for realizing the service 100. The flow information table T114, for example, associatively manages a management number C1141, a flow number C1142, a component identifier list C1143, and a component property group list C1144.

The flow number C1142 is for identifying a flow. The component identifier list C1143 is a list of identifiers of software components 101 that configure the flow identified in the flow number C1142. The component property group list C1144 is a list of the names of software component 101 property groups configuring this flow.

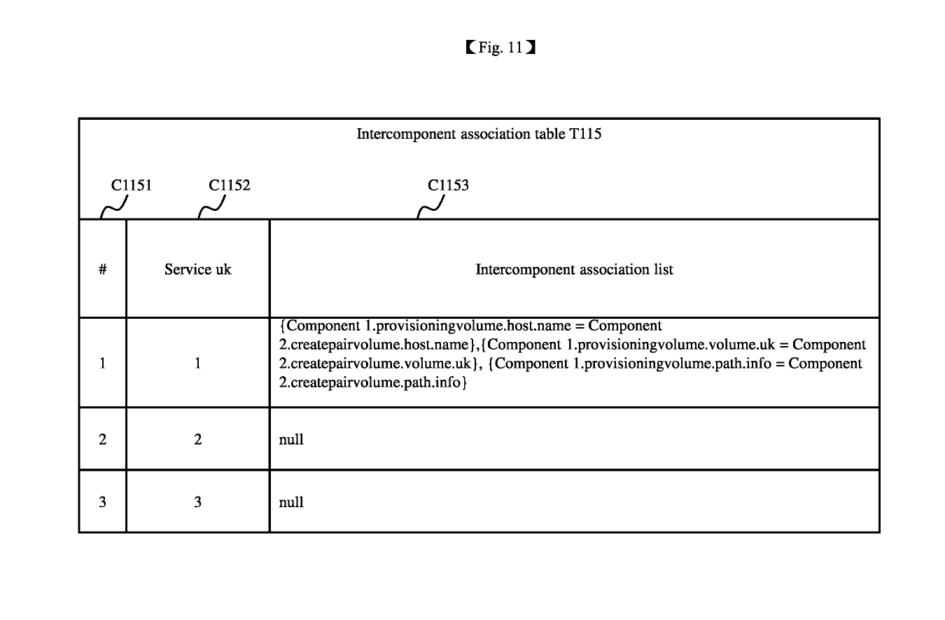

FIG. 11 is the intercomponent association information table T115 for managing information showing an association between the software components. The intercomponent association information table T115, for example, associatively manages a management number C1151, a service identifier C1152, and an intercomponent association list C1153. The intercomponent association list C1153 is information showing how the plurality of software components that configure the flow are associated with one another. The intercomponent association list C1153 defines which of the output values of the first software component 101(1) is used as the input value of the second software component 101(2). Furthermore, the contents shown in FIG. 11 do not correspond to the contents shown in FIG. 1.

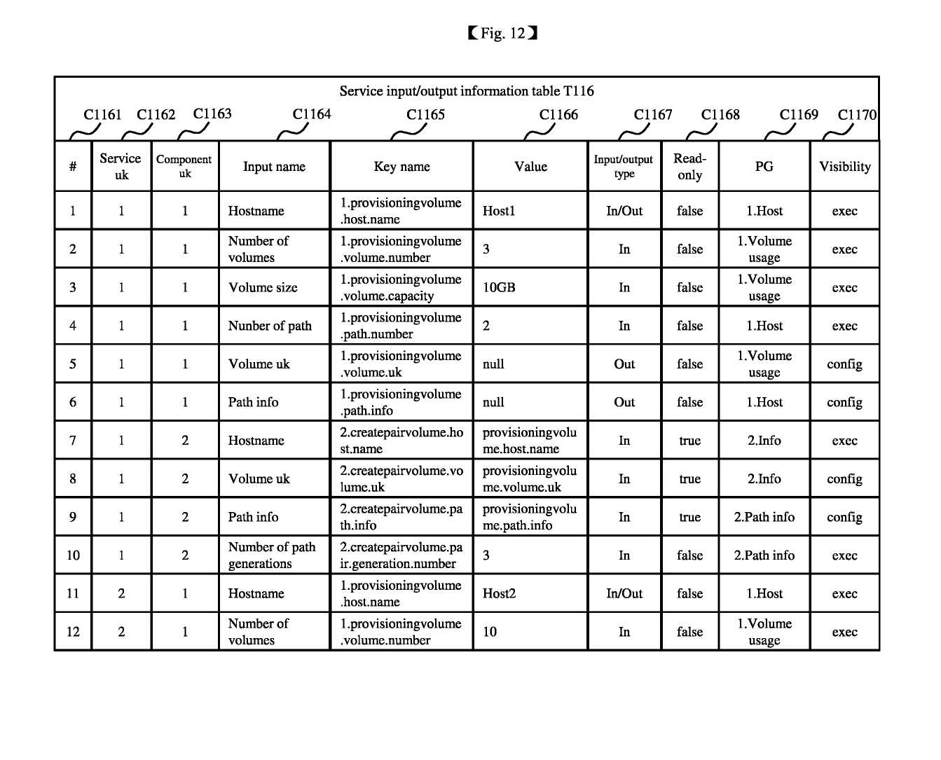

FIG. 12 shows the service input/output information table T116 for managing information inputted/outputted to the service 100. The service input/output information table T116, for example, associatively manages a management number C1161, a service identifier C1162, a component identifier C1163, an input name C1164, a key name C1165, a value C1166, an input/output type C1167, a read-only flag C1168, a property group C1169, and visibility information C1170.

The identifiers C1163 of the plurality of software components are associated with the service identifiers C1162. As was explained using the component information table T112, the input name C1164, the key name C1165, the value C1166, the input/output type C1167, and the property group name C1169 are associated with each software component. Since these items C1164 to C1167, C1169 and C1170 are the same as C1123 to C1126, C1127, and C1128 described using the component information table T112 shown in FIG. 8, explanations thereof will be omitted.

The read-only flag C1168 is information for distinguishing whether or not information is inputtable. A case where “false” is configured in the read-only flag C1168 of the input property identified in the key name C1165 shows that this input property is not in the read-only state and can be inputted by the user. By contrast, an input property for which “true” is configured in the read-only flag C1168 is in the read-only state and cannot be inputted by the user. That is, since an output value of the other software component is automatically inputted to the read-only state input property, the user is unable to perform an input manually.

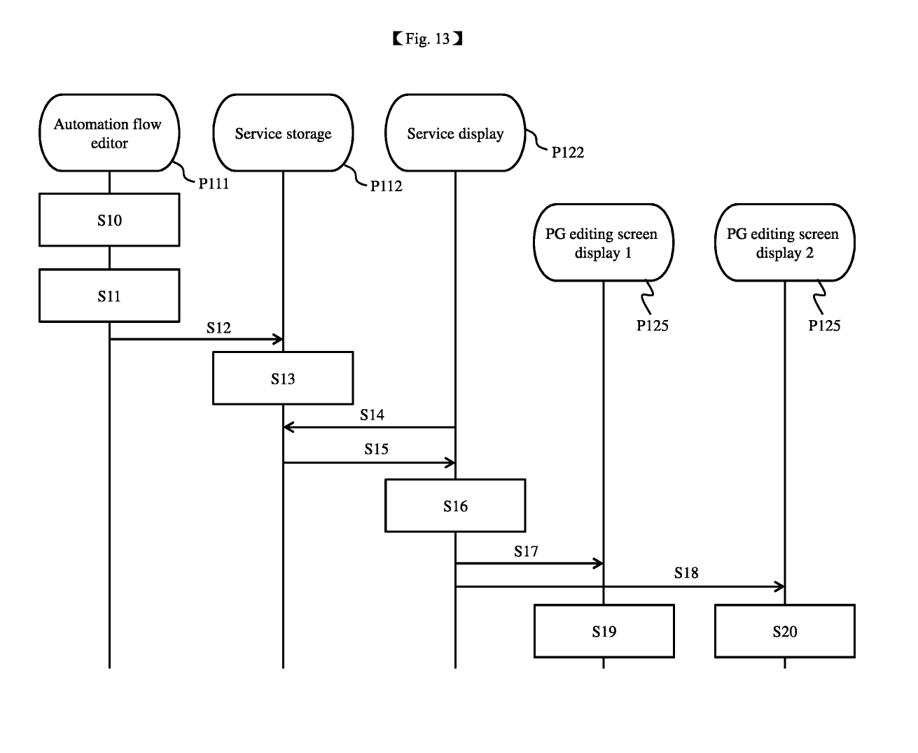

The processing and so forth for creating and executing the service 100 for automating system operations will be explained using FIGS. 13 to 17.

FIG. 13 is a sequence chart showing the overall operation for displaying a service editing screen. First, the user initially edits the operation automation flow using the screen for editing the operation automation flow (S10).

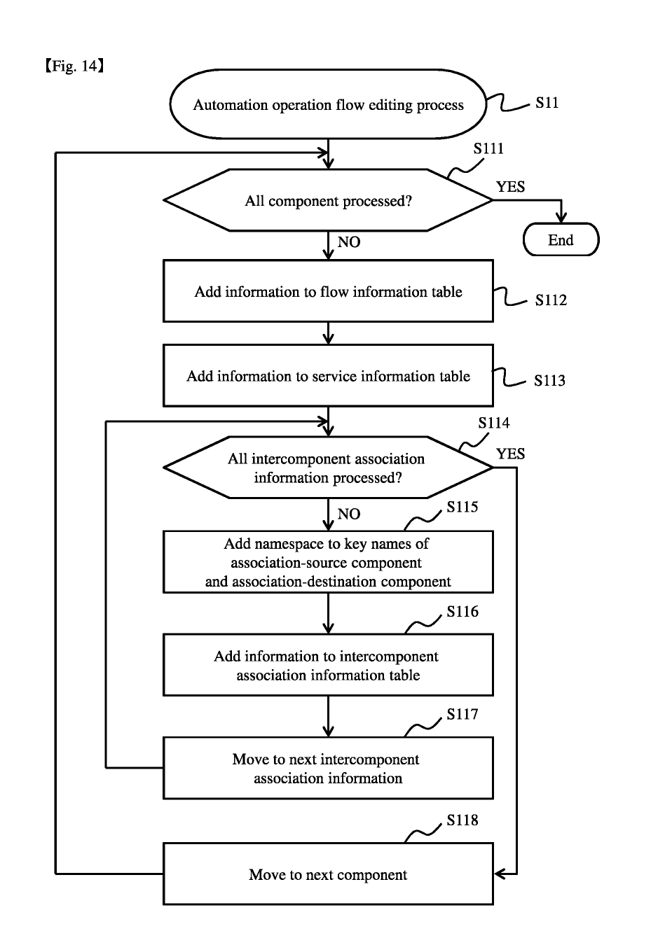

When the flow is created, the automation flow editing program P111 associates user-edited flow information with service basic information such as the service name (S11). The automation flow editing program P111 transmits the information associated in Step S11 to the service storage program P112 (S12). Step S11 will be explained in detail later using FIG. 14.

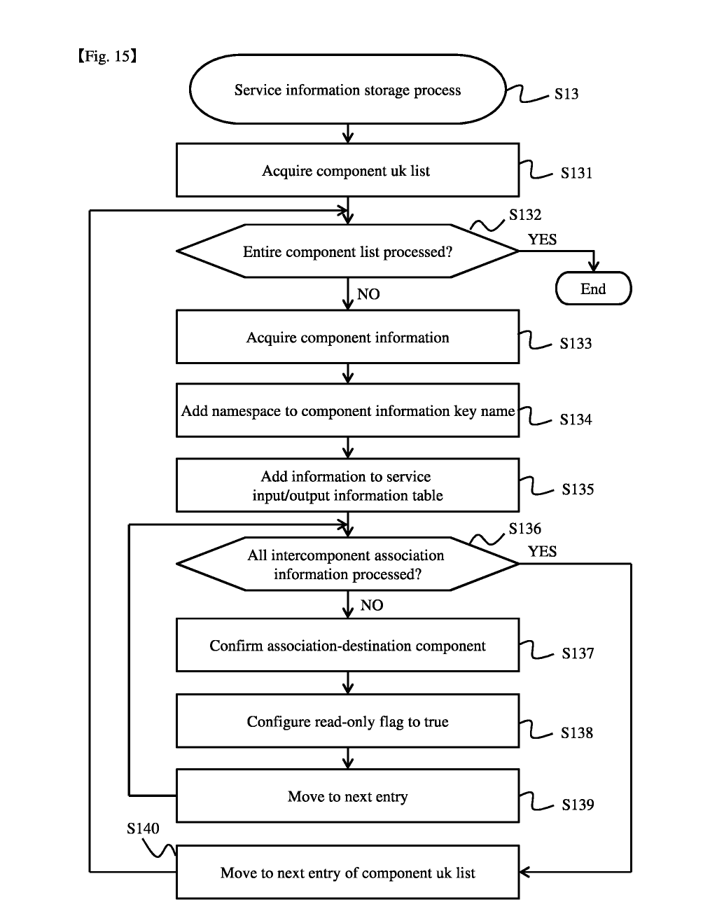

The service storage program P112, which stores information regarding the service, determines data (an input property) to be inputted to the service and data (an output property) to be outputted from the service on the basis of received information, and stores same (S13). Step S13 will be explained in detail later using FIG. 15.

When the user performs an operation requesting use of the service editing screen, the service display program P122 for displaying the service editing screen transmits a display-target service name to the service storage program P112 (S14).

Upon receiving the service name, the service storage program P112 transmits information regarding the service corresponding to the service name and information regarding the flow created for realizing this service to the service display program P122 (S15).

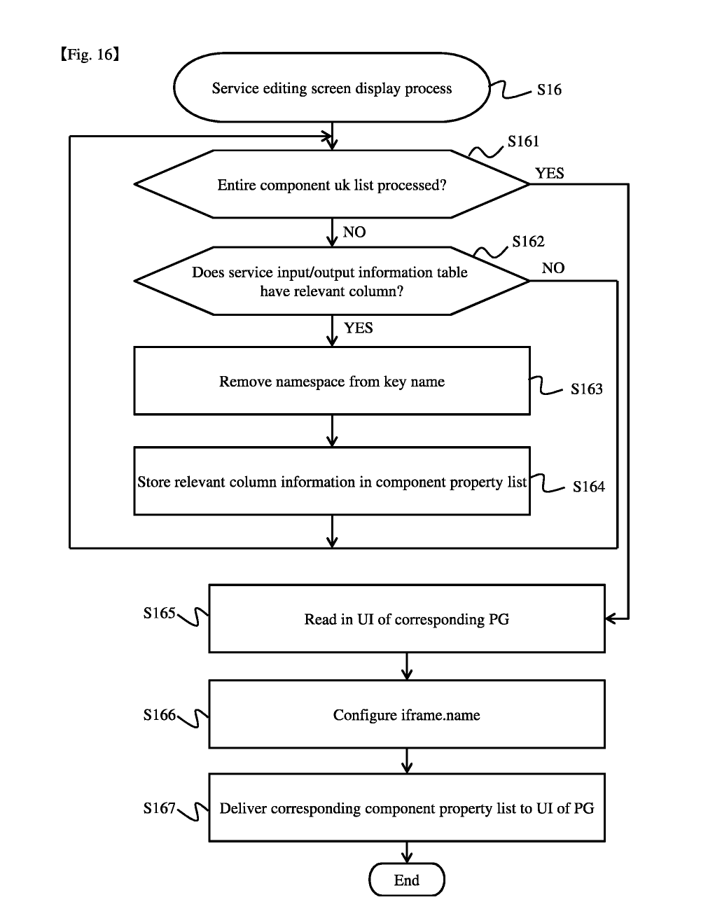

The service display program P122 classifies the information received from the service storage program P112 by property group, and determines whether or not an input is required for each property (S16). A determination as to whether or not an input is required by the user can be made from the value of the read-only flag C1168 of the service input/output information table T116. Step S16 will be explained in detail later using FIG. 16.

The service display program P122 transmits information regarding an input-required property of a property group to the property group editing screen display program P125 corresponding to the property group that includes this property (S17, S18).

The program P125 for displaying the property group editing screen displays the property included in this property group in each user interface (property group user interface) (S19, S20).

FIG. 14 is a flowchart showing the details of Step S11 executed by the automation flow editing program P111.

First, the automation flow editing program P111 initially determines whether all the software components 101 included in the user-edited flow have been processed (S111). In a case where all the software components 101 have been processed (S111: YES), this processing ends. The flow targeted by this processing may be called the target flow. A processing-target software component may be called the target software component. In the drawings, a software component that configures the target flow is displayed as “component”.

In a case where an unprocessed software component 101 exists (S111: NO), the automation operation flow editing program P111 saves the software component identifier (uk), and a namespace, which is a flow step name (in this example, “1”, “2” and so forth, for example) to the flow information table T114.

A namespace and a property group name are associatively saved to the component property group list C1144 of the flow information table T114 so as to uniquely identify each property. When a plurality of the same or the same type of software components are included in the flow, there is the likelihood of key names being duplicated, but each property of each property group can be uniquely identified by associating the namespace with the property group name.

The automation operation flow editing program P111 stores service basic information and flow numbers in the service information table T113 (S113). The service name C1132, the service identifier C1133, and the service details C1134 are included in the service basic information. The flow number is the number configured in the target flow, and is stored in the flow number C1135 of the service information table T113.

The automation operation flow editing program P111 determines whether all of the intercomponent association information related to the target software component has been processed (S114). In a case where unprocessed intercomponent association information exists (S114: NO), the automation operation flow editing program P111 stores the intercomponent association information and the service identifier C1152 for identifying the service in the intercomponent association information table T115 (S115, S116).

The intercomponent association information is created by associating the key name of an association-source software component with the key name of an association-destination software component, and saving this association in the intercomponent association list C1153 of the intercomponent association information table T115.

A namespace, which is the step number of the relevant software component, is prepended to the key name of the association-source software component (S115). Similarly, the relevant software component namespace is also prepended to the key name of the association-destination software component (S115). The automation operation flow editing program P111 stores the intercomponent association information thus created in the intercomponent association information table T115 (S116).

The automation operation flow editing program P111 repeatedly executes steps S114 to S116 until all the intercomponent association information for the target software component is processed (S117). When the processing for the target software component is complete (S114: YES), the automation operation flow editing program P111 targets the next software component included in the target flow for processing (S118), and returns to Step S111.

FIG. 15 is a flowchart showing the details of the processing (S13) for storing the service information executed by the service storage program P112.

The service storage program P112 retrieves the service information table T113 on the basis of the service name included in the information received from the automation operation flow editing program P111, and identifies the flow number corresponding to the service name. The service storage program P112 retrieves the flow information table T114 on the basis of the identified flow number, and acquires a list of component identifiers of the software components for configuring the target flow (S131).

The service storage program P112 determines whether processing has been performed for all the software components listed in the component identifier list acquired in Step S131 (S132). When it is determined that all the software components listed in the component identifier list have been processed (S132: YES), the service storage program P112 ends this processing.

When an unprocessed software component exists (S132: NO), the service storage program P112 regards the unprocessed software component as the target software component, and acquires information corresponding to the identifier of the target software component from the component information table T112 (S133). The service storage program P112 prepends the namespace to the key name C1124 in the component information acquired from the component information table T112 (S134).

The service storage program P112 saves the component information for which the namespace was added to the key name, the service identifier, and the read-only flag to the service input/output information table T116 (S135). At this time point, “false” is configured in all the read-only flags.

In addition, the service storage program P112 acquires from the intercomponent association information table T115 an intercomponent association list related to the flow number identified in Step S131, and determines whether all of the associations between software components (intercomponent association information) listed in the acquired intercomponent association list have been processed (S136).

In a case where unprocessed intercomponent association information exists (S136: NO), the service storage program P112 confirms the key name of the association-destination software component in the intercomponent association information (S137). The service storage program P112 configures the value of the read-only flag C1168 that coincides with the key name of the association-destination software component to “true” in the service input/output information table T116 (S138).

The service storage program P112 moves to the next intercomponent association information listed in the intercomponent association list (S139), and returns to Step S136. When all of the intercomponent association information listed in the intercomponent association list has been processed like this (S132: YES), the service storage program P112 ends this processing.

FIG. 16 is a flowchart of the processing for displaying the service editing screen. This processing corresponds to Step S16 of FIG. 13, and is executed by the service display program P122.

The service display program P122, on the basis of the flow number stored in the flow number C1135 of the service information table T113, refers to the flow information table T114 and determines whether all the software components listed in the component identifier list C1143 have been processed (S161).

In a case where an unprocessed software component exists (S161: NO), the service display program P122 determines whether a column having the same identifier as that of the identifier of the unprocessed software component exists in the service input/output information table T116 (S162).

When it is determined that a corresponding column exists (S162: YES), the service display program P122 acquires the value of the key name C1165 and removes the namespace from this value (S163).

The service display program P122 adds the column information and the removed namespace to a component property list (not shown in the drawing) provided in the memory 112 (S164). The service display program P122 repeats Steps S161 to S164 until each software component configuring the flow is processed.

When all the software components listed in the list have been processed (S161: YES), the service display program P122 reads in the user interface of the property group (S165). The service display program P122, for example, uses an API (Application Programming Interface) of an iframe (inline frame) of the HTML (HyperText Markup Language) to read in the user interface of the corresponding property group based on the namespace, the property group name, and the screen type.

The iframe is an example of a screen configuration technique for embedding an HTML file in an HTML file. A technique other than this may be used to embed a user interface screen for each property group in the service provision screen G10. The service display program P122 configures “<NAMESPACE>-<property group name>-<screen type>” in an iframe.name (S166).

Lastly, the service display program P122 reads property information that coincides with the namespace and property group name from the component property list inside the memory 112, and transmits this information to the corresponding property group user interface (S167).

As was described using FIG. 13, the user interface of each property group displays the property belonging to the relevant property group in a specific display area of the service provision screen G10. A display content and a display range are determined by adding read-only information and visibility information for displaying at this time (S19, S20).

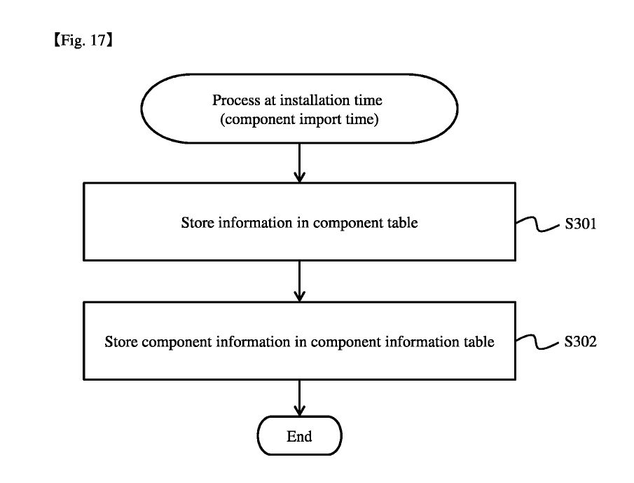

FIG. 17 shows the processing when installing a software component 101 in the storage operation automation system 1.

First, the storage operation automation system 1 initially stores the component name and software component identifier of the installation-target software component 101 in the component table T111 (S301). Next, the storage operation automation system 1 stores information regarding the installation-target software component 101 in the component information table T112 (S302).

Because this example is configured as described above, the following effects are achieved. In this example, the flow of the service 100 is configured from a plurality of software components 101, and an individual user interface 103 for each property group is configured beforehand in each software component 101. Therefore, interfaces can be automatically created for the entire service in accordance with the user simply editing the contents (flow) of the service 100.

In this example, a user interface is configured beforehand for each property group, user interfaces can easily be created for the entire service even in a case where a combination of software components has changed.

In addition, in this example, the relationship between a plurality of software components configuring the flow is analyzed, and in a case where an output property of a connection-source (association-source) software component is used as an input property of a connection-destination (association-destination) software component, the user interface is configured so that the user is not able to input to this input property. Therefore, erroneous data can be prevented from being inputted, and human error can be averted.

### Example 2

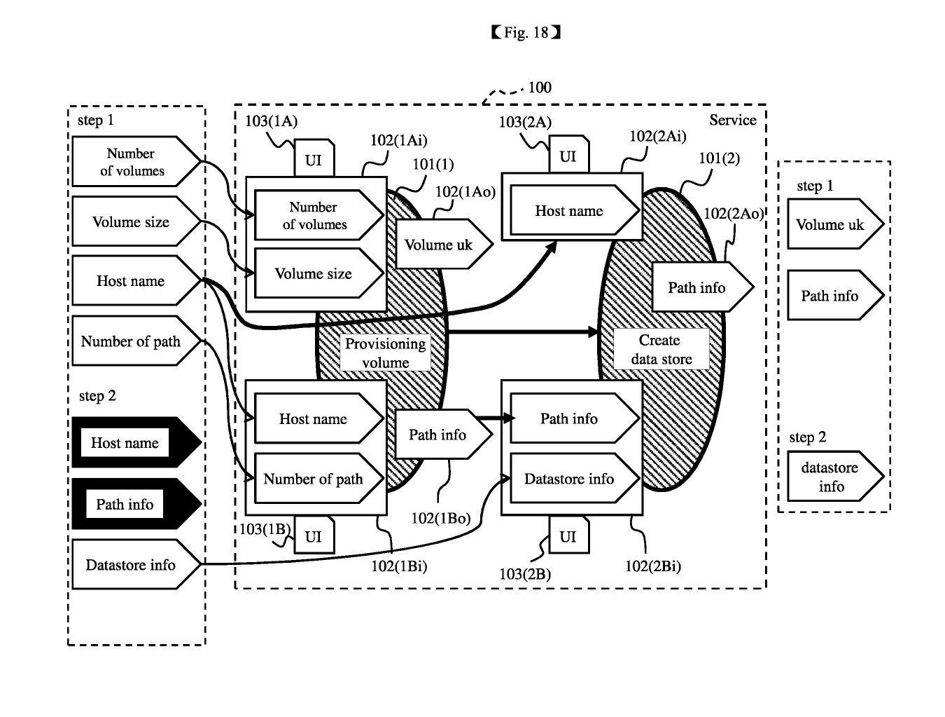

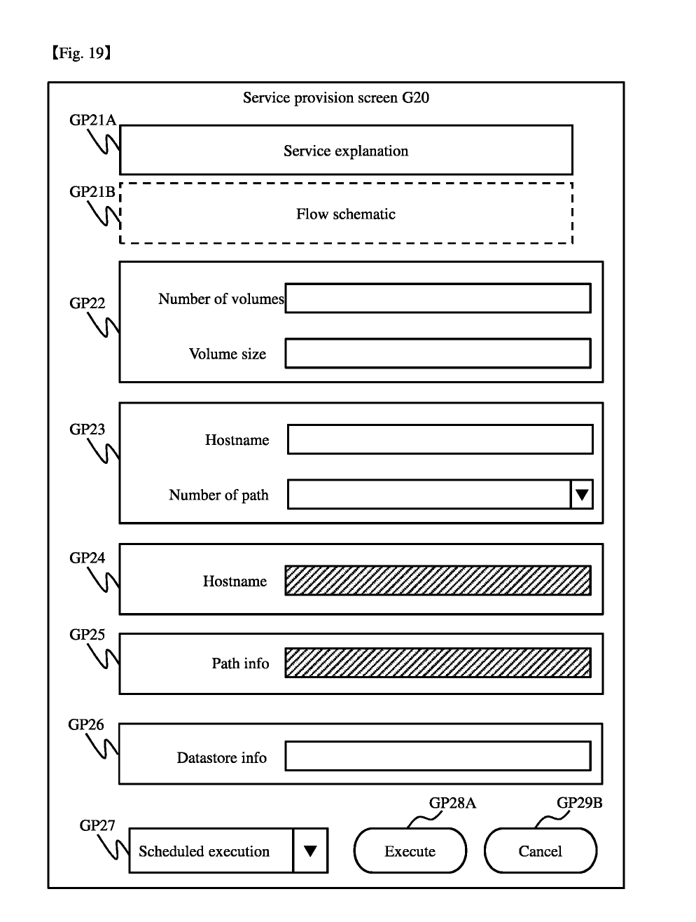

A second example will be explained using FIGS. 18 and 19. This example and those that follow correspond to modification examples of the first example. Therefore, the explanation of this example will focus on differences with the first example. FIG. 18 is a schematic diagram showing the relationship between the service 100 and each software component 101(1) and 101(2) according to this example.

This example also realizes the service 100 in accordance with a flow configured by combining a first software component 101(1) with a second software component 101(2). The first software component 101(1) creates a thin provisioning volume. The second software component 101(2) creates a datastore inside the thin provisioning volume created by the first software component 101(1).

Here the input property “hostname” exists in both the first software component 101(1) and the second software component 101(2). The “hostname” inputted to the first software component (1) must be the same as the “hostname” inputted to the second software component 101(2). This is because the host 3 that is able to access the thin provisioning volume created by the first software component 101(1) uses the datastore in this thin provisioning volume. Therefore, in this example, the user-inputted “hostname” in the first software component 101(1) is used as-is in the second software component 101(2) as well.

For the above-stated reason, “path information” outputted from the first software component 101(1) should also be used as input in the second software component 101(2). Accordingly, in this example, the “path information” outputted from the first software component 101(1) is used as-is as input data in the second software component 101(2).

FIG. 19 shows a service provision screen G20 according to this example. The service provision screen G20, for example, is provided with a service overview part GP21, a volume setup part GP22, a host setup part GP23 that uses the thin provisioning volume, a host setup part GP24 that uses the datastore, a path information setup part GP25, a datastore information setup part GP26, an execution type specification part GP27, and a button GP28.

Service overview part GP21 is a generic term that includes a service explanation part GP21A and a flow schematic GP21B the same as was described in the first example.

Each setup part GP22 to GP26 corresponds to a user interface 103 of the input property groups 102(i) of the respective software components 101. The volume setup part GP22 corresponds to the user interface 103(1A) of the input property group 102(1Ai) of the first software component 101(1). The user inputs the number of thin provisioning volumes created and the sizes of the volumes to the volume setup part GP22.

The one host setup part GP23 corresponds to the user interface 103(1B) of the input property group 102(1Bi) of the first software component 101(1). The user inputs to the host setup part GP23 a hostname for identifying the host that uses the thin provisioning volume, and a number of paths that connect to the thin provisioning volume.

The other host setup part GP24 corresponds to the user interface 103(2A) of the input property group 102(2Ai) of the second software component 101(2). The “hostname” used by the second software component 101(2) must be the same as the “hostname” used by the first software component 101(1). Accordingly, the other host setup part GP24 is displayed so that the user is unable to input a “hostname”.

Since the path information setup part GP25 also automatically uses path information determined by the first software component 101(1), this setup part GP25 is displayed so that the user is unable to make an input.

The datastore information setup part GP26 enables the user to configure information related to the datastore.

The execution type specification part GP27 is the same as the execution type specification part GP16 in the first example, and therefore an explanation will be omitted. Button GP28 is a generic term for an execute button GP28A and a cancel button GP28B. Since the button GP28 is the same as the button GP17 in the first example, an explanation will be omitted.

This example is configured so as to achieve the same effects as the first example. In addition, in this example, the second software component 101(2) has an input property that uses data that is the same as the data inputted to the first software component 101(1), and an input property that uses data outputted from the first software component 101(1). Thus, this example is able to support both a case in which data shared in common between the respective software components is input, and a case where the output of the first software component 101(1) is used as the input of the second software component 101(2). Therefore, the scope for automatically creating a service user interface can be broadened, thereby further enhancing usability.

### Example 3

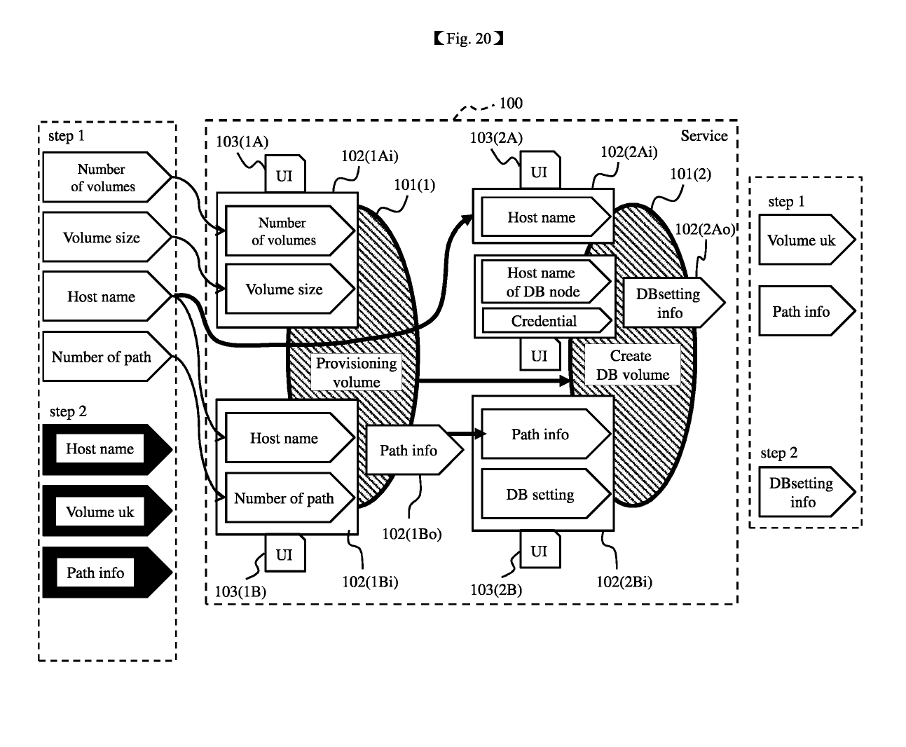

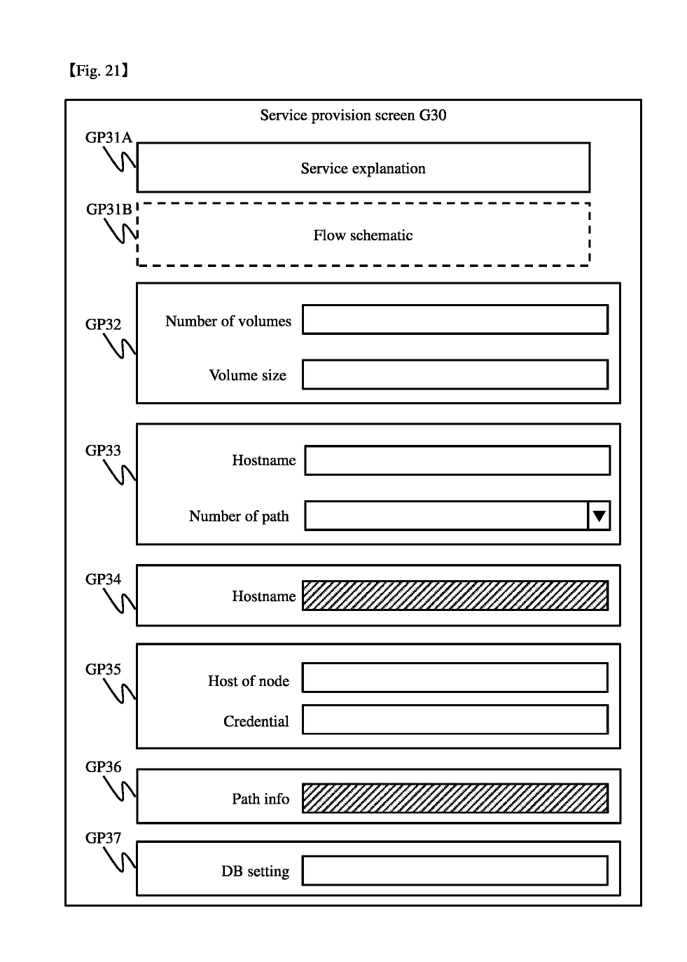

A third example will be explained using FIGS. 20 and 21. FIG. 20 is a schematic diagram showing a relationship between the service 100 and the respective software components 101 according to this example.

In this example, a thin provisioning volume is created by the first software component 101(1), and a communication path is configured for connecting the created thin provisioning volume to the host 3. The second software component 101(2) performs initialization for using this thin provisioning volume as a volume for database use.

In this example, the input property “hostname” also exists in both the first software component 101(1) and the second software component 101(2) the same as in the second example. The “hostname” inputted to the first software component (1) must be the same as the “hostname” inputted to the second software component 101(2). This is because the host 3 that is able to access the thin provisioning volume created by the first software component 101(1) uses the database volume formed from this thin provisioning volume. Therefore, in this example as well, the “hostname” inputted by the user to the first software component 101(1) is also used as-is in the second software component 101(2).

The “path information” outputted from the first software component 101(1) is also used as an input of the second software component 101(2). Accordingly, in this example, the “path information” outputted by the first software component 101(1) is used as-is as input data in the second software component 101(2).

Since the thin provisioning volume created by the first software component 101(1) and the database volume initialized by the second software component 101(2) are the same volume, a “volume identifier” need not be inputted for the second software component 101(2).

FIG. 21 shows a service provision screen G30 according to this example. The service provision screen G30, for example, is provided with a service overview part GP31, a volume setup part GP32, a host setup part GP33 that uses the thin provisioning volume, a host setup part GP34 that uses the database volume, a credential setup part GP35 for configuring a node and credential information, a path information setup part GP36, and a database setup part GP37. Although omitted from FIG. 21, the service provision screen G30 is also provided with an execution type specification part and a button the same as in the first and second examples.

Service overview part GP31 is a generic term that includes a service explanation part GP31A and a flow schematic GP31B.

Each of the setup parts GP32 to GP37 corresponds to a user interface 103 of the input property groups 102(i) of the respective software components 101. The volume setup part GP32 corresponds to the user interface 103(1A) of the input property group 102(1Ai) of the first software component 101(1). The user inputs the number of thin provisioning volumes created and the sizes of the volumes to the volume setup part GP22.

The one host setup part GP33 corresponds to the user interface 103(1B) of the input property group 102(1Bi) of the first software component 101(1). The user inputs to the host setup part GP23 a hostname for identifying the host that uses the thin provisioning volume, and a number of paths that connects to the thin provisioning volume.

The other host setup part GP34 corresponds to the user interface 103(2A) of the input property group 102(2Ai) of the second software component 101(2). Here, the “hostname” used by the second software component 101(2) must be the same as the “hostname” used by the first software component 101(1). Accordingly, the other host setup part GP34 is displayed so that the user is unable to input a “hostname”.

The user is able to configure node credential information in the credential information setup part GP35. Since the path information setup part GP36 automatically uses path information determined by the first software component 101(1), this setup part GP36 is displayed so that the user is unable to make an input.

The database setup part GP37 is displayed so that the user is able to configure information required to use the thin provisioning volume as a database volume. This example is configured so as to achieve the same effects as the second example.

### Example 4

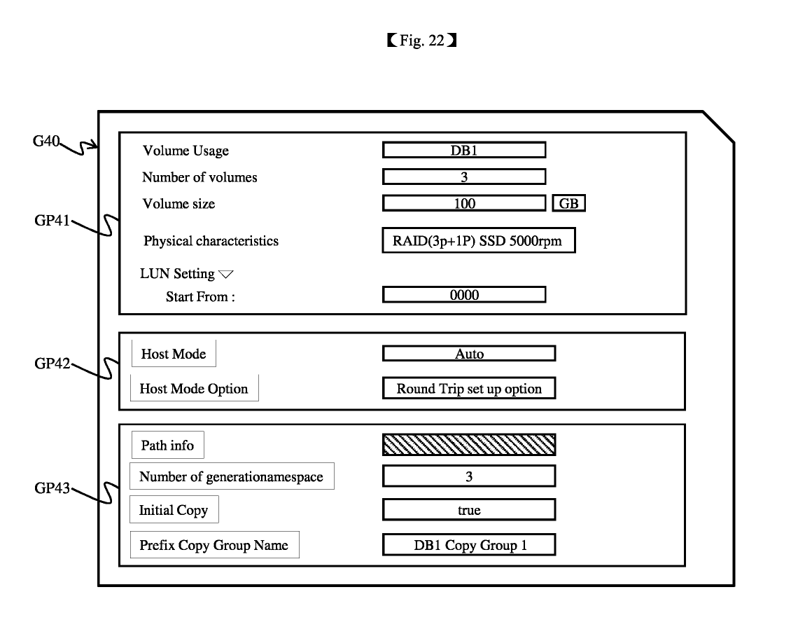

A fourth example will be explained using FIGS. 22 to 24. In this example, the content displayed on the service 100 user interface is changed in accordance with the attribute of the user who is using the service 100 user interface. The user using the service 100 user interface is a service 100-related user, and, for example, can be classified as a user having service 100 editing authority, or a user who instructs the execution of the service 100. Here, a user having service 100 editing authority is called a storage administrator, and a user who instructs the execution of the service 100 is called an operator.

In addition, in this example, the content displayed on the service 100 user interface is changed at each of a plurality of stages at which this content is configured beforehand for the service 100. The plurality of stages, for example, include an editing stage, an execution instruction confirmation stage, and an execution results confirmation stage. Thus, in this example, the display content of the service 100 is change in accordance with both the attribute of the service 100-related user and a prescribed plurality of stages.

FIG. 22 shows an example of a screen G40 at the editing stage. The service editing screen G40 can only be displayed and manipulated on the information display apparatus 12 by the storage administrator. The service editing screen G40 is provided so that the storage administrator can configure the content (flow) of the service 100 in a detailed manner.

The editing screen G40 shown in FIG. 22, for example, is provided with a volume setup part GP41, a host setup part GP42, and a path information setup part GP43. Furthermore, service provision screens G40, G50, and G60 of this example can also be provided with service overview parts, execution type specification parts, and buttons, but drawings illustrating these parts have been omitted.

In the volume setup part GP41, the storage administrator, for example, is able to configure a number of created volumes, volume sizes, pool physical characteristics for creating the volumes, an LUN (Logical Unit Number) that is to be used. In the host setup part GP42, the storage administrator, for example, is able to configure a host mode, and a host mode option. In the path information setup part GP43, the storage administrator is able to configure an instruction as to whether or not to execute an initial copy, a copy mode, and a prefix for copy group names.

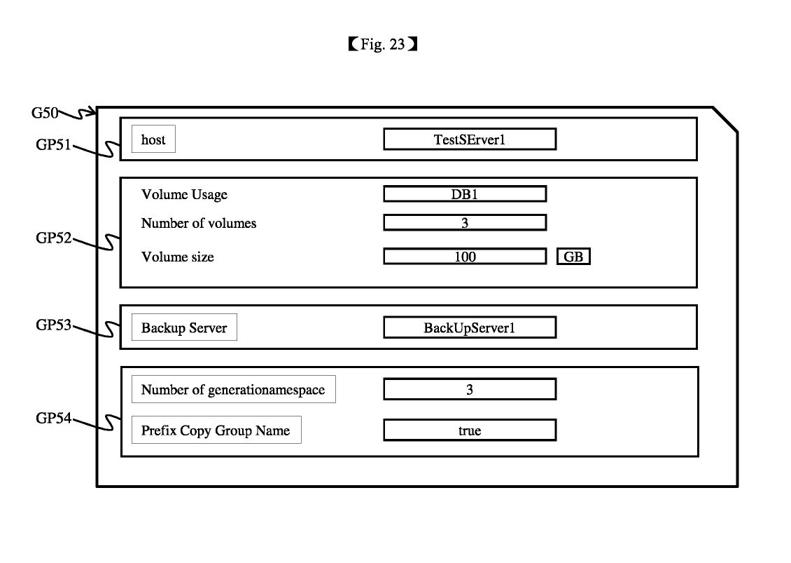

FIG. 23 shows an example of an execution instruction confirmation screen G50. The screen G50 for confirming a service execution instruction displays only the items that the operator needs to configure for each task to be executed.

The execution instruction confirmation screen G50, for example, is provided with a host setup part GP51, a volume setup part G52, another host setup part (backup server setup part) GP52, and a number of path generations setup part GP54.

In the host setup part GP51, the operator is able to specify an arbitrary host that is being managed using an apparatus-management product. In the volume setup part GP52, the operator, for example, is able to configure the number and sizes of the volumes to be allocated to a host from within a pool having physical characteristics that have been specified in advance. In the number of path generations setup part GP54, the operator, for example, can specify a number of copy group generations, and a prefix for copy group names.

Thus, in the execution instruction confirmation screen G50, the operator can only access and manipulate limited information compared to the information provided to the storage administrator. The operator is not able to manipulate information such as a host mode that has been configured in advance by the storage administrator. Such unauthorized information may be displayed on the screen G50 in a for-reference-only mode.

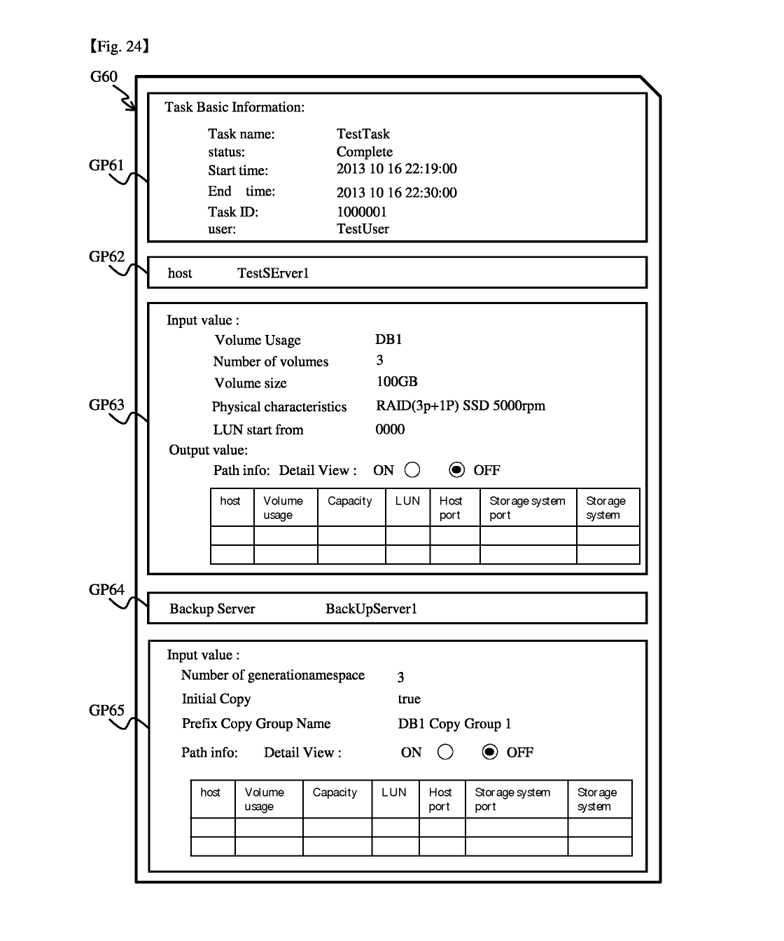

FIG. 24 shows an example of an execution result confirmation screen G60. The screen G60 for confirming the result of service execution is configured so that the storage administrator is able to confirm all information related to the results of task execution without distinguishing between operators.

The execution result confirmation screen G60, for example, is provided with an execution result display part GP61, a host information display part GP62, a volume information display part GP63, another host information display part (backup server display part) GP64, and a number of path generations information display part GP65.

In the execution result display part GP61, which shows basic information regarding an execution result, the storage administrator and the operator, for example, can confirm a task name, a task status, a task start time, a task end time, a task identifier, and a user name. In the host information display part GP62, the storage administrator and the operator, for example, can confirm the name of the host that is using the primary volume (copy-source volume).

In the volume information display part GP63, the storage administrator and the operator, for example, can confirm the usage of a created volume, the number of volumes, the size of the volumes, the physical characteristics of the pool that was used to create the volumes, a LUN, and path information. In the other host information display part GP64, the storage administrator and the operator, for example, can confirm the name of the other host.

In the number of path generations information display part GP65, the storage administrator and the operator, for example, can confirm the number of generations of a copy group, whether or not an initial copy has been implemented, a prefix for copy group names, and path information.

In the execution result confirmation screen G60, the storage administrator and the operator are able to reference both values that were specified prior to task execution (prior to service execution) and values that were obtained as a result of task execution. Furthermore, as shown in the display parts GP63 and GP65, a “Detail View” button is provided for controlling the display of detailed information, and detailed information can be displayed or deleted by switching this button ON/OFF.

This example is also configured so as to achieve the same effects as the other examples. In addition, in this example, the content displayed on the service provision screen is controlled in accordance with the attribute of a service-related user and a prescribed stage at which the content is configured in advance for the service. Therefore, the user is able to confirm and manipulate information within a range that he himself needs, thereby enhancing usability. Furthermore, in this example, an example in which the screen configuration is controlled in accordance with both the user attribute and a prescribed stage was explained, but the screen configuration can be controlled in accordance with the user attribute alone, or the screen configuration can be controlled in accordance with the prescribed stage of the service alone. These configurations can be easily understood and implemented by a person having ordinary skill in the art, and as such detailed explanations will be omitted.

The present invention is not limited to the examples described hereinabove. A person having ordinary skill in the art will be able to make various additions, changes, and so forth without departing from the scope of the present invention. For example, the above-described technical features of the present invention can be implemented by being combined as appropriate.

### REFERENCE SIGNS LIST

1 Storage operation automation system
2 Storage management system
3 Host computer
4 Storage apparatus

1. A user interface creation system that creates a user interface for a prescribed process executed using a computer,
wherein the prescribed process is created by combining a plurality of sub-process steps for executing prescribed sub-processes, the sub-process steps each having a sub-process user interface that corresponds to a sub-process content,
the user interface creation system being configured to:
detect the sub-process steps comprising the prescribed process; and
create a general user interface for use in the prescribed process, using the sub-process user interfaces of the detected sub-process steps.

2. The user interface creation system according to claim 1, wherein input data required for the prescribed process is determined on the basis of input data and output data for the sub-processes comprising the prescribed process, and the general user interface is created on the basis of the required input data.

3. The user interface creation system according to claim 2, wherein other input data, besides the required input data of the input data of the sub-processes comprising the prescribed process, is configured so as to be uninputtable in the general user interface.

4. The user interface creation system according to claim 3, wherein, in a case where output data of one sub-process step of the sub-process steps comprising the prescribed process can be used as input data of another sub-process step of the sub-process steps comprising the prescribed process, the input data of the other sub-process step is configured so that a user is not able to input this input data in the general user interface.

5. The user interface creation system according to claim 3, wherein, in a case where input data of one sub-process step of the sub-process steps comprising the prescribed process is the same as input data of another sub-process step of the sub-process steps comprising the prescribed process, data to be used in common as input data of the one sub-process step and as input data of the other sub-process step is configured so that the user is able to input this data in the general user interface.

6. The user interface creation system according to claim 1, wherein a display content of the general user interface changes in accordance with an attribute of a user who uses the general user interface.

7. The user interface creation system according to claim 1, wherein a display content of the general user interface changes for each of a plurality of pre-configured stages related to the prescribed process.

8. The user interface creation system according to claim 7, wherein the general user interface display content differs at each of an editing stage for editing contents of the prescribed process, an execution stage for instructing execution of the edited prescribed process, and an execution result stage for showing an execution result of the prescribed process.

9. A user interface creation method for creating a user interface of a prescribed process executed using a computer,
wherein the prescribed process is created by combining a plurality of sub-process steps for executing prescribed sub-processes, the sub-process steps each having a sub-process user interface that corresponds to a sub-process content,
the user interface creation method comprising:
detecting the sub-process steps comprising the prescribed process;
acquiring the sub-process user interfaces of the detected the sub-process steps; and
creating a general user interface by arranging the acquired sub-process user interfaces on a screen prepared beforehand for creating the general user interface for use in the prescribed process.

10. The user interface creation method according to claim 9, wherein input data required for the prescribed process is determined on the basis of input data and output data for the sub-processes comprising the prescribed process, and the general user interface is created on the basis of the required input data.

11. The user interface creation method according to claim 10, wherein other input data, besides the required input data of the input data of the sub-processes comprising the prescribed process, is configured to be uninputtable in the general user interface.

12. The user interface creation method according to claim 11, wherein, in a case where output data of one sub-process step of the sub-process steps comprising the prescribed process can be used as input data of another sub-process step of the sub-process steps comprising the prescribed process, the input data of the other sub-process step is configured so that a user is not able to input this input data in the general user interface.

13. The user interface creation method according to claim 11, wherein, in a case where input data of one sub-process step of the sub-process steps comprising the prescribed process is the same as input data of another sub-process step of the sub-process steps comprising the prescribed process, data to be used in common as input data of the one sub-process step and as input data of the other sub-process is configured so that the user is able to input this data in the general user interface.

14. The user interface creation method according to claim 9, wherein a display content of the general user interface is changed in accordance with an attribute of a user who uses the general user interface.

15. The user interface creation method according to claim 9, wherein a display content of the general user interface is changed for each of a plurality of pre-configured stages related to the prescribed process.
